(19) United States
(12) Patent Application Publication
(10) Pub. No.: US 2007/0114757 A1
(43) Pub. Date: May 24, 2007

(54) Systems and methods for releasing electrical connectors on cabs of tractor-trailers

(76) Inventor: Samuel C. Vickroy, Madison, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/510,071

(22) Filed: Aug. 25, 2006

Related U.S. Application Data
(60) Provisional application No. 60/711,226, filed on Aug. 25, 2005.

(51) Int. Cl. B60D 1/62

(52) U.S. Cl. 280/422

(57) ABSTRACT

An apparatus for safely releasing an electrical connector from a socket on the back of a cab has a handle contiguous with at least one lever and the handle has an aperture. The apparatus further has a collar pivotally attached to the handle that receives and rigidly retains the electrical connector and a pulling apparatus, such as a chain, affixed to the aperture of the handle on a first end and a trailer on a second end such that when the cab drives away from the trailer, the pulling apparatus actuates the handle and the levers exhibit a force on the collar such that the collar pulls the electrical connector from the socket.

### CROSS REFERENCE TO RELATED APPLICATION

This application claims priority to U.S. Provisional Application No. 60/711,226, entitled “Apparatus and Method for Connecting an Electrical Connector,” and filed on Aug 25, 2005, which is incorporated herein by reference.

### RELATED ART

A tractor-trailer typically comprises a cab attached to a trailer. A driver drives the tractor-trailer from the cab. The trailer usually comprises a housing in which goods or freight is located for transport from one place to another.

The trailer is datachably coupled to the cab. In addition to connections for coupling the trailer to the cab, there are typically other types of connections between the cab and the trailer, such as, for example, a connector that receives a cable, hereinafter referred to as a “pigtail,” that supplies power from a power supply in the cab, e.g., the battery, to the trailer. Such power is necessary to supply power to brake lights, for example, or lights within the trailer for visible inspection of the freight when it is dark.

When a driver has completed a job, he typically detaches the trailer from the cab and drives the cab to a different location than the trailer. Oftentimes, the driver may forget to manually disconnect the electrical connector from the cab. Thus, when the driver drives away from the trailer, the force pulls the pigtail from the connector on the cab. Such force may result in damage to the electrical connector on the cab, to the pigtail, or to the cab itself.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 depicts a tractor-trailer having an electrical connector release system in accordance with an exemplary embodiment of the present disclosure.

FIG. 2 depicts a plan view of a release device depicted in FIG. 1.

FIG. 3 depicts a perspective view of the release device of FIG. 1 retaining an electrical connector.

FIG. 4 depicts a perspective view of the release device of FIG. 3 inserted into an electrical socket of a cab.

FIG. 5 depicts a tractor-trailer having an electrical connector release system in accordance with an exemplary embodiment of the present disclosure.

### DETAILED DESCRIPTION

Embodiments of the present disclosure generally pertain to systems and methods for detaching an electrical connector of an electrical cable, such as a pigtail, from an electrical socket of a tractor-trailer cab. Particularly, an apparatus in accordance with an exemplary embodiment of the present disclosure provides a lever that rests against the cab, and when the trailer is detached from the cab and the cab drives away from the trailer, the lever actuates via force applied by a chain. When the lever actuates, the lever pulls the electrical connector from the electrical socket without causing damage to the cab, the pigtail, or the electrical connector.

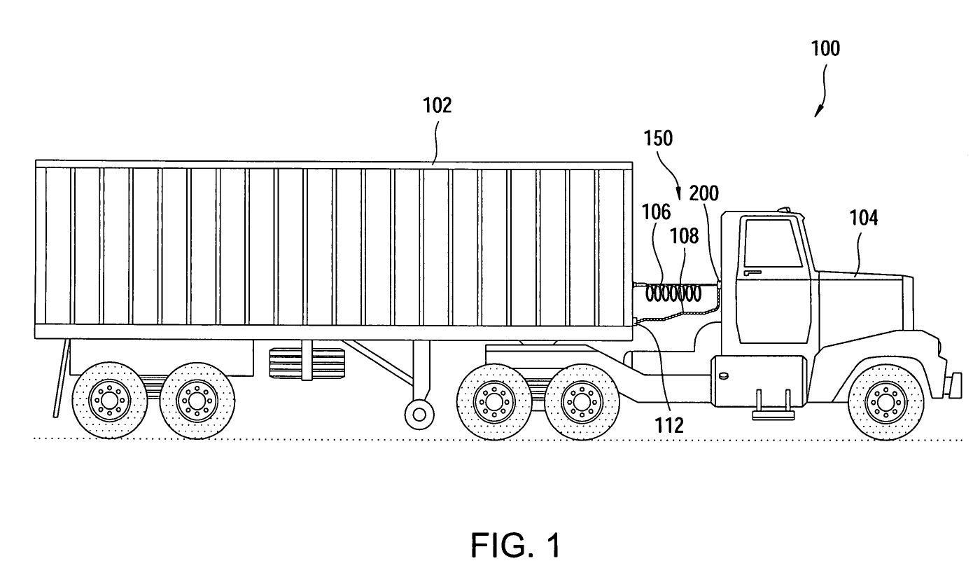

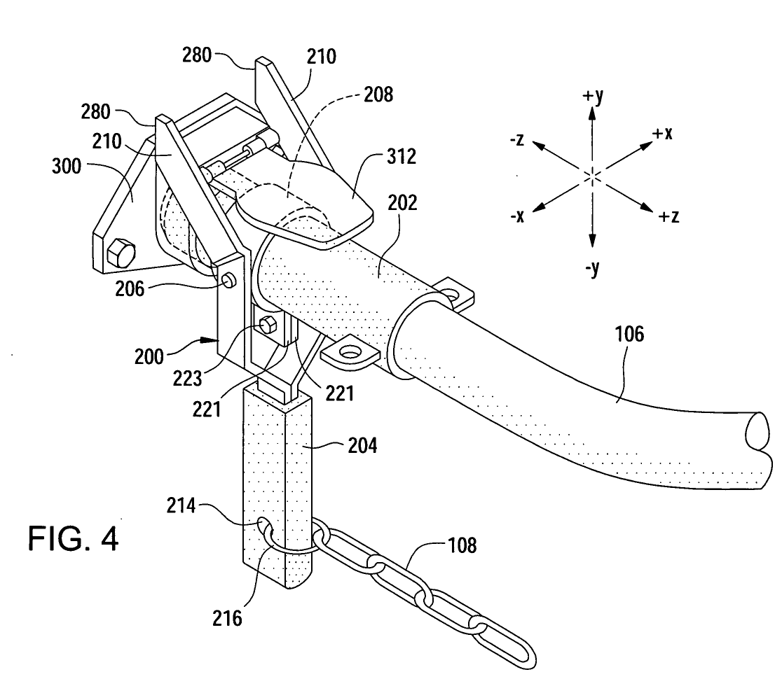

FIG. 1 depicts a tractor-trailer 100 comprising a cab 104 and a trailer 102. The cab 104 is electrically coupled to the trailer 102 via a pigtail 106, although other types of electrical cables may be used in other embodiments. In this regard, the trailer 102 comprises an electrical socket (not shown) and the cab 104 comprises an electrical socket described in more detail with reference to FIG. 4, and the pigtail 106 electrically connects the trailer socket and the cab socket. A releasing system 150 comprising a release device 200, a pulling apparatus 108, and a connection device 112 automatically disconnects the pigtail 106 from the trailer socket if the distance between the cab 104 and trailer 102 reaches a threshold distance. An exemplary configuration of the system 150 will be described in more detail hereinbelow.

As shown by FIG. 1, the release device 200 is connected to a pulling apparatus 108, such as a chain, a cord, a rope, or the like. In the exemplary embodiment depicted by FIGS. 1 and 3-5, the pulling apparatus 108 is a chain, but other types of apparatuses may be used in other embodiments. The pulling apparatus 108 is connected to the trailer 102 via a connection device 112. Such a connection device 112 may be any connection device known in the art. For example, the connection device 112 depicted by FIG. 1 comprises a loop that is attached to the pulling apparatus 108. In such an example, the apparatus 108 may have a hook that passes through the loop to secure the apparatus 108 to the loop. Alternatively, the apparatus 108 may be tied to the loop. Various other techniques of connecting the apparatus 108 to the trailer 102 are possible in other examples.

In operation, if the cab 104 is detached from the trailer 102, and a driver (not shown) pulls the cab 104 away from the trailer 102 without detaching the pigtail 106, the release device 200 is actuated by a force caused by the apparatus 108 pulling on the release device 200 when the cab 104 pulls away from the trailer 102, which is described in more detailer hereafter.

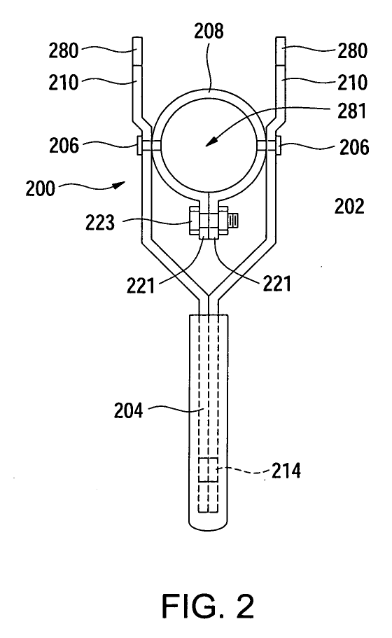

FIG. 2 depicts a release device 200 in accordance with an exemplary embodiment of the present disclosure. The release device 200 is shown in a collapsed position, which will be described further hereafter.

The release device 200 comprises a collar 208 and two levers 210 pivotally attached to the collar 208 via pins 206. Each of the levers 210 comprises a portion 280 that sits against a surface, for example the surface of the cab 104.

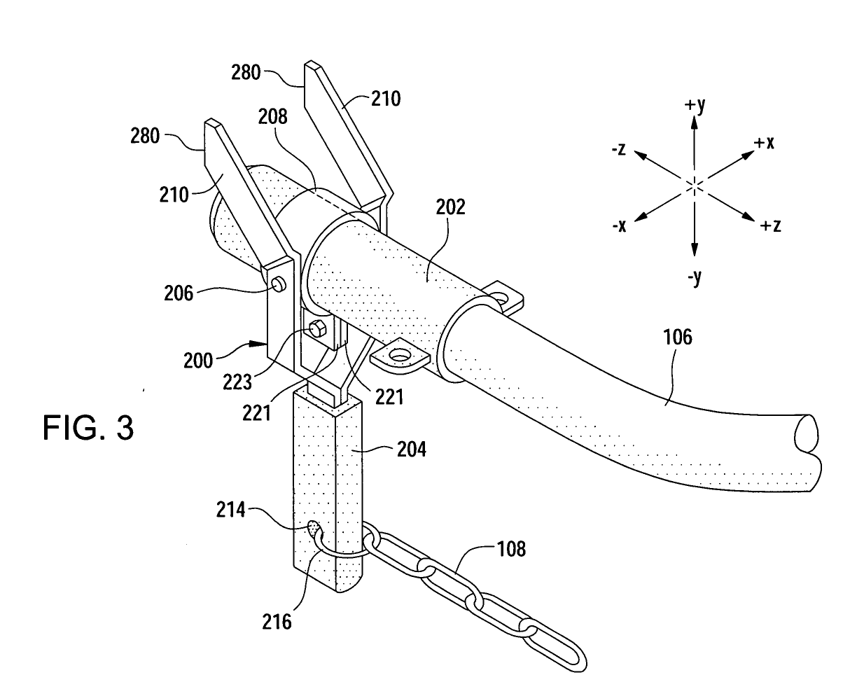

The collar 208 has flanges 221 through which a screw 223 passes. In this regard, the collar 208 can slide over an electrical connector 202 (FIG. 3), which connects the pig tail 106 to a socket on the cab 104. The collar 208 can then be tightened snug on the connector 202 by adjusting the screw 223.

The release device 200 further has a handle 204. The handle 204 rotates about the pins 206, as described herein. Thus, if the portions 280 rest against a cab 104, and the handle 204 is actuated, the levers 210 pull the connector 202 from a socket to which it is connected.

The handle 204 further has an opening 214. The opening 214 extends through the handle 204 and receives a chain or other type of pulling apparatus. Thus, if the pulling apparatus is attached to a trailer 102 and the trailer 102 remains stationery while the cab 104 moves away from the trailer 102, then the pulling apparatus pulls the handle 204 thereby actuating the levers 210 and pulling the connector 202 from the socket of the cab.

FIG. 3 depicts a release device 200 attached to an electrical connector 202. FIG. 3 further depicts a pigtail 106 terminated by the electrical connector 202. As described hereinabove, the electrical connector 202 is inserted into the opening 281 (FIG. 2). The collar 208 is then tightened via the screw 223, which adjusts the ends 221 of the collar 208 as the screw 223 is tightened.

As described hereinabove, the levers 210 are pivotally attached to the handle 204. Thus, when the handle 204 is actuated in a +z direction, the levers 210 move in a −z direction rotating about the pins 206. Therefore, the portions 280, if situated against a surface of the cab 104, will cause force in the +z direction of the electrical connector 202.

Furthermore, the release device 200 further comprises an aperture 214 within the handle 204 as described hereinabove. Such a handle 204 is attached to the pulling apparatus 108. As shown in FIG. 1, the apparatus 108 is further attached to the trailer 102 via a connector 112. Thus, if the trailer 102 and the cab 104 are detached and the cab 104 moves away from the trailer 102, then the apparatus 108 will pull on the handle 204 in the +z direction. When the handle 204 is pulled in such a direction, the levers 210 pivot about the pins 206. Thus, if the portions 280 are situated against a surface, the force of the levers 210 pivoting about the pins 206 will cause the electrical connector 202 attached to the collar 208 be pulled in the +z direction.

FIG. 4 depicts the connector 202 coupled to a socket 300 that is preferably on the back of the cab 104. The electrical connector 202 is attached to the release device 200 via the collar 208 and the screw 223. Furthermore, the portions 280 of the levers 210 are situated against the back of the cab 104 or against the socket 300.

When the cab 104 pulls away from the trailer 102 and the connector 202 has not been removed from the socket 300, the apparatus 108 actuates the handle 204 in the +z direction. The levers 210 pivot about the pins 206, which cause the portions 280 to press against the cab 104. The force caused by the portions 280 pressing against the cab 104 generates a force in the +z direction that disconnects the electrical connector 202 from the socket 300. Therefore, no damage is cause to the socket 300, the cab 104, or the pigtail 106 if the driver (not shown) forgets to manually remove the pigtail 106 from the socket 300 before he drives the cab 104 away from the trailer 102.

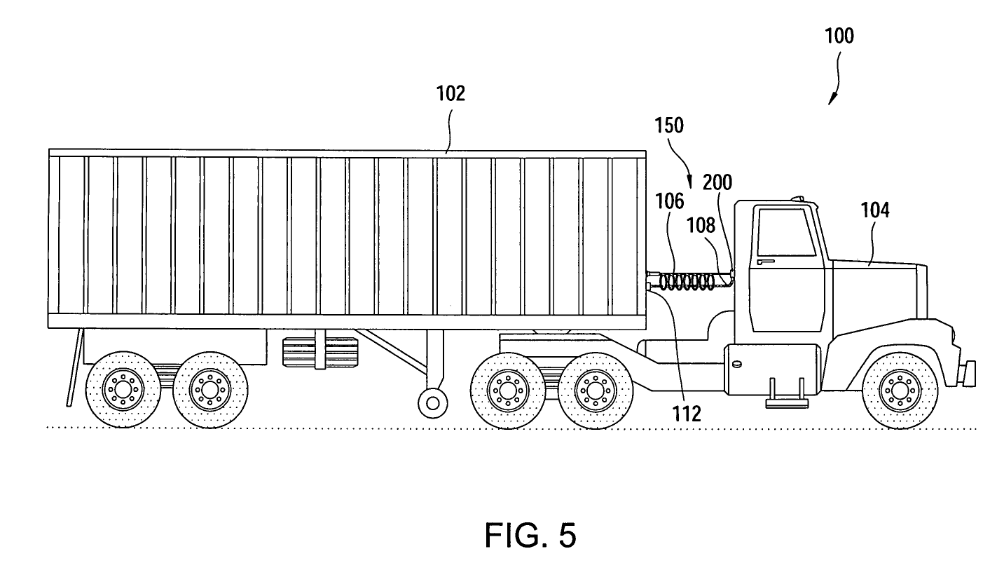

In one exemplary embodiment, as illustrated in FIG. 5, the pulling apparatus 108 passes through the loops formed by the pigtail 106. In such an embodiment, portions of the apparatus 108 are prevented from drooping below the pigtail 106 as slack develops in the apparatus 108 due to changes in the orientation of the cab 104 with respect to the trailer 102 (e.g., as the cab 104 turns during operation).

In other examples, the pulling apparatus 108 may be attached to a portion of the pigtail 106 or other component between the cab 104 and trailer 102 rather than being attached to the trailer 102. In such an example, it may be more difficult to control the release of the pigtail 106 in a desired manner. For example, if the apparatus 108 is attached to the pigtail 106, changes in the slack of the pigtail 106 due to changes in the orientation of the cab 104 with respect to the trailer 102 may cause the pigtail 106 to be released during normal operation when the trailer 102 is still connected to the cab 104. Moreover, selecting the precise location on the pigtail for attaching the pulling apparatus 108 so that release of the pigtail 106 is controlled in a desired manner as the orientation of the cab 104 changes may be difficult.

Now, therefore, the following is claimed:

1. A system, comprising:
a socket mounted on a cab of a tractor-trailer;
an electrical cable extending from the cab to a trailer of the tractor-trailer;
an electrical connector terminating an end of the electrical cable, the connector electrically coupled to the socket;
a release device coupled to the connector; and
a pulling apparatus coupled to the release device and the trailer such that the pulling apparatus automatically actuates the release device based on a distance between the cab and the trailer, wherein the release device, when actuated, disconnects the connector from the socket.

2. The system of claim 1, wherein the pulling apparatus comprises a chain.

3. The system of claim 1, wherein the pulling apparatus comprises a cord.

4. The system of claim 1, wherein the pulling apparatus comprises a rope.

5. The system of claim 1, wherein the release device has a pivotable lever, and wherein the pulling apparatus causes the lever to pivot when the cab moves a threshold distance from the trailer.

6. A system, comprising:
a release device coupled to an electrical connector terminating an end of an electrical cable and electrically coupled to a socket mounted on a cab of a tractor-trailer, the cable extending from the cab to a trailer of the tractor trailer; and
a pulling apparatus coupled to the release device and the trailer such that the pulling apparatus pulls a component of the release device when a distance between the cab and the trailer reaches a threshold distance thereby automatically releasing the connector from the socket.

7. The system of claim 6, wherein the pulling apparatus comprises a chain.

8. The system of claim 6, wherein the pulling apparatus comprises a cord.

9. The system of claim 6, wherein the pulling apparatus comprises a rope.

10. A method, comprising the steps of:
coupling an electrical connector to a socket mounted on a cab of a tractor-trailer, the connector terminating an electrical cable coupled to a trailer of the tractor-trailer;
coupling a release device to the connector;
coupling a pulling apparatus to the trailer and to the release device; and
moving the cab from the trailer such that the pulling apparatus actuates the release device thereby releasing the connector from the socket.

11. The method of claim 10, wherein the pulling apparatus comprises a chain.

12. The method of claim 10, wherein the pulling apparatus comprises a rope.

13. The method of claim 10, wherein the pulling apparatus comprises a cord.

15. The method of claim 10, wherein the release device comprises a pivotable lever, and wherein the lever pivots when the release device is actuated.
